(19) United States
(12) Patent Application Publication
(10) Pub. No.: US 2014/0172531 A1
(43) Pub. Date: Jun. 19, 2014

(54) PERFORMING TRANSACTIONS USING QR CODES

(71) Applicants: Michael A. Liberty, Windermere, FL (US); Steve Bacastow, Cumming, GA (US); Robert Sadeckas, Lakewood, OH (US)

(72) Inventors: Michael A. Liberty, Windermere, FL (US); Steve Bacastow, Cumming, GA (US); Robert Sadeckas, Lakewood, OH (US)

(21) Appl. No.: 14/106,282

(22) Filed: Dec. 13, 2013

Related U.S. Application Data
(60) Provisional application No. 61/737,523, filed on Dec. 14, 2012.
(60) Provisional application No. 61/759,851, filed on Feb. 1, 2013.
(60) Provisional application No. 61/812,570, filed on Apr. 16, 2013.

(51) Int. Cl. G06Q 20/32

(52) U.S. Cl. CPC G06Q 20/3276
USPC 705/14.23; 705/41; 705/26.8

(57) ABSTRACT

Embodiments are directed to performing transactions using a quick response (QR) code, and to directly purchasing items from a seller using a QR code. In one scenario, a computer system receives, from a purchaser, an indication of items that are to be purchased using a mobile wallet application, and determines a total price for those items. The computer system then receives a tokenized QR code that includes embedded account information for the purchaser. The computer system generates a second tokenized QR code that includes encrypted account information for the seller, along with encrypted account information for the purchaser and the determined total price for the items that are to be purchased, and sends the second tokenized QR code to a transaction processing node where the money is transferred. The computer system then receives an electronic receipt indicating that the money was transferred from the purchaser's account to the seller's account.

### CROSS-REFERENCE TO RELATED APPLICATIONS

This application claims priority to and the benefit of the following provisional applications: U.S. Provisional Pat. App. No. 61/737,523, entitled “Performing Transactions Using QR Codes”, filed on Dec. 14, 2012, U.S. Provisional Pat. App. No. 61/759,851, entitled “Performing Transactions Using QR Codes”, filed on Feb. 1, 2013, and U.S. Provisional Pat. App. No. 61/812,570, entitled “Direct Purchase of Goods or Services Using QR Codes”, filed on Apr. 16, 2013, each of which is incorporated by reference herein in its entirety.

### BACKGROUND

Computers have become highly integrated in the workforce, in the home, in mobile devices, and many other places. Computers can process massive amounts of information quickly and efficiently. Software applications designed to run on computer systems allow users to perform a wide variety of functions including business applications, schoolwork, entertainment and more. Software applications are often designed to perform specific tasks, such as word processor applications for drafting documents, or email programs for sending, receiving and organizing email.

Today's smart phones use software applications to perform a wide variety of functionality. In some cases, this functionality may include the ability to pay for items using a mobile payment system. Such a mobile payment system may allow users to pay for items at a store or over the internet using their phone.

### BRIEF SUMMARY

Embodiments described herein are directed to performing a transaction using a quick response (QR) code, directly purchasing items from a seller using a QR code and to performing a transaction at a restaurant using a QR code. In one embodiment, a computer system receives, from a purchaser, an indication of items that are to be purchased using a mobile wallet application. The computer system determines a total price for those items that are to be purchased and then receives, from the purchaser, a tokenized QR code that includes embedded account information for the purchaser for use in processing transactions with sellers. The computer system then generates a second, different tokenized QR code that includes encrypted account information for the seller, along with encrypted account information for the purchaser and the determined total price for the items that are to be purchased, and sends the second tokenized QR code to a transaction processing node. The transaction processing node transfers money equivalent to the determined total price from the purchaser's account to the seller's account according to the encrypted account information in the second tokenized QR code. The computer system then receives an electronic receipt indicating that the money was transferred from the purchaser's account to the seller's account.

In another embodiment, a computer system facilitates directly purchasing items from a seller using a QR code. The computer system receives from a purchaser a tokenized QR code indicating that the purchaser has initiated a financial transaction using a mobile wallet application to pay for items sold by a seller. The tokenized QR code includes embedded account information for both the seller and the purchaser. The computer system determines, from the tokenized QR code, the amount of money that is to be transferred from the purchaser to the seller as part of the financial transaction, and selects which stored value account belonging to the purchaser is to be used to pay for the items provided for sale by the seller. The computer system then transfers the determined amount of money from the selected stored value accounts to the seller's account, according to the embedded account information in the tokenized QR code, and sends an electronic receipt of the financial transaction to the purchaser and/or the seller.

In yet another embodiment, a computer system facilitates performing a transaction at a restaurant using a QR code. The computer system receives from a restaurant customer a tokenized QR code indicating that the restaurant customer is using a mobile wallet application to pay for menu items sold by the restaurant. The tokenized QR code includes embedded account information for both the restaurant and the restaurant customer, an indication of which menu items are being purchased, an indication of the total amount due, and an indication of payment instructions for the restaurant. The computer system determines which payment network is to be used to pay for the selected menu items, transfers the money indicated in the total amount due to from the restaurant customer's account to the restaurant's account, and sends an electronic receipt of the transaction to the restaurant customer and/or the restaurant.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a computer architecture in which embodiments described herein may operate including performing and facilitating monetary transactions.

FIG. 2 illustrates a computer architecture in which transactions are performed using a quick response (QR) code.

FIG. 3 illustrates an alternative computer architecture in which transactions are performed using a QR code.

FIG. 4 illustrates a computer architecture in which transactions are performed at a restaurant using a QR code.

FIG. 5 illustrates a computer architecture for directly purchasing items from a seller using a QR code.

FIG. 6 illustrates a flowchart of a method for performing a transaction using a QR code.

FIG. 7 illustrates a flowchart of a method for directly purchasing items from a seller using a QR code.

FIG. 8 illustrates a flowchart of a method for perform a method for performing a transaction at a restaurant using a QR code.

FIG. 9 illustrates a computer architecture in which geofences are implemented in conjunction order fulfillment for restaurant customers.

FIG. 10 illustrates an example embodiment of a customer order received at a restaurant.

### DETAILED DESCRIPTION

Embodiments described herein are directed to performing a transaction using a quick response (QR) code, directly purchasing items from a seller using a QR code and to performing a transaction at a restaurant using a QR code. In one embodiment, a computer system receives, from a purchaser, an indication of items that are to be purchased using a mobile wallet application. The computer system determines a total price for those items that are to be purchased and then receives, from the purchaser, a tokenized QR code that includes embedded account information for the purchaser for use in processing transactions with sellers. The computer system then generates a second, different tokenized QR code that includes encrypted account information for the seller, along with encrypted account information for the purchaser and the determined total price for the items that are to be purchased, and sends the second tokenized QR code to a transaction processing node. The transaction processing node transfers money equivalent to the determined total price from the purchaser's account to the seller's account according to the encrypted account information in the second tokenized QR code. The computer system then receives an electronic receipt indicating that the money was transferred from the purchaser's account to the seller's account.

In another embodiment, a computer system facilitates directly purchasing items from a seller using a QR code. The computer system receives from a purchaser a tokenized QR code indicating that the purchaser has initiated a financial transaction using a mobile wallet application to pay for items sold by a seller. The tokenized QR code includes embedded account information for both the seller and the purchaser. The computer system determines, from the tokenized QR code, the amount of money that is to be transferred from the purchaser to the seller as part of the financial transaction, and selects which stored value account belonging to the purchaser is to be used to pay for the items provided for sale by the seller. The computer system then transfers the determined amount of money from the selected stored value accounts to the seller's account, according to the embedded account information in the tokenized QR code, and sends an electronic receipt of the financial transaction to the purchaser and/or the seller.

In yet another embodiment, a computer system facilitates performing a transaction at a restaurant using a QR code. The computer system receives from a restaurant customer a tokenized QR code indicating that the restaurant customer is using a mobile wallet application to pay for menu items sold by the restaurant. The tokenized QR code includes embedded account information for both the restaurant and the restaurant customer, an indication of which menu items are being purchased, an indication of the total amount due, and an indication of payment instructions for the restaurant. The computer system determines which payment network is to be used to pay for the selected menu items, transfers the money indicated in the total amount due to from the restaurant customer's account to the restaurant's account, and sends an electronic receipt of the transaction to the restaurant customer and/or the restaurant.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. A computing system may be distributed over a network environment and may include multiple constituent computing systems.

As described herein, a computing system typically includes at least one processing unit and memory. The memory may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

As used herein, the term “executable module” or “executable component” can refer to software objects, routings, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory of the computing system. Computing system may also contain communication channels that allow the computing system to communicate with other message processors over a wired or wireless network.

Embodiments described herein may comprise or utilize a special-purpose or general-purpose computer system that includes computer hardware, such as, for example, one or more processors and system memory, as discussed in greater detail below. The system memory may be included within the overall memory 103. The system memory may also be referred to as “main memory”, and includes memory locations that are addressable by the at least one processing unit 102 over a memory bus in which case the address location is asserted on the memory bus itself. System memory has been traditional volatile, but the principles described herein also apply in circumstances in which the system memory is partially, or even fully, non-volatile.

Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program pa code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

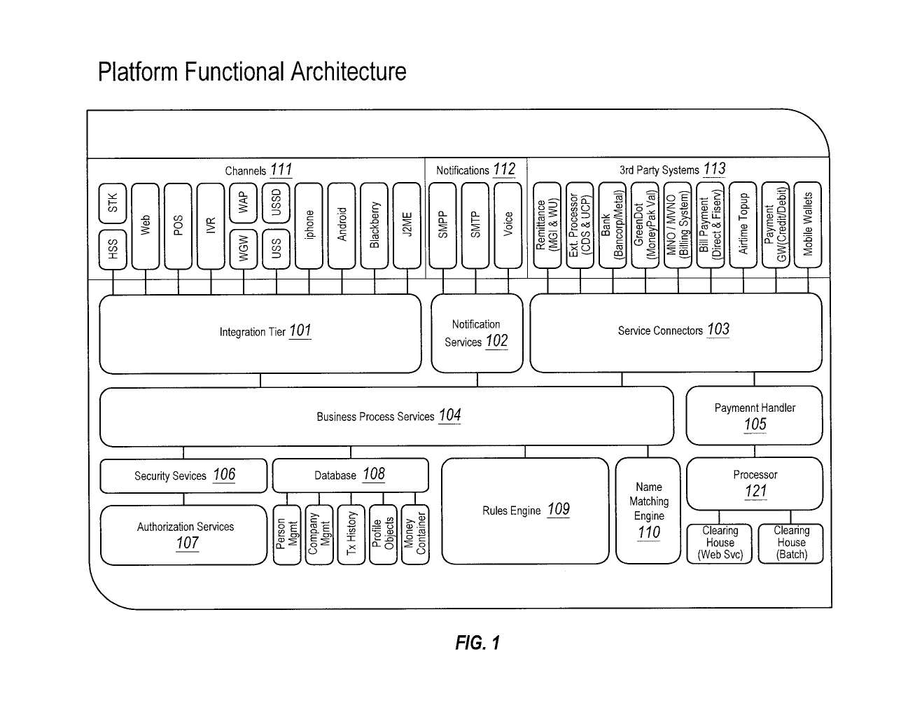

FIG. 1 illustrates an example system architecture for a mobile wallet platform. Integration tier 101 is configured to manage mobile wallet sessions and maintain integrity of financial transactions. Integration tier 101 can also include a communication (e.g., Web services) API and/or other communication mechanisms to accept messages from channels 111. Other mechanisms include, but are not limited to: International Standards Organization (“ISO”) 8583 for Point of Sale (“POS”) and Automated Teller Machines (“ATM”) devices and Advanced Message Queuing Protocol (“AMQP”) for queue based interfaces. Each of channels 111 can be integrated to one or more mechanisms for sending messages to integration tier 101. Notification services 102 is configured to send various notifications through different notification channels 112, such as, for example, Short Message Peer-to-Peer (“SSMP”) for Short Messaging Service (“SMS”) and Simple Mail Transfer Protocol (“SMTP”) for emails. Notification services 102 can be configured through a web services API.

Service connectors 103 are a set of connectors configure to connect to 3rd party systems 113. Each connector can be a separate module intended to integrate an external service to the system architecture. Business process services 104 are configured to implement business workflows, including executing financial transactions, auditing financial transactions, invoking third-party services, handling errors, and logging platform objects. Payment handler 105 is configured to wrap APIs of different payment processors, such as, for example, banking accounts, credit/debit cards or processor 121. Payment handler 105 exposes a common API to facilitate interactions with many different kinds of payment processors.

Security services 106 are configured to perform subscriber authentication. Authorization services 107 are configured to perform client authorization, such as, for example, using a database-based Access Control List (“ACL”) table.

Database 108 is configured to manage customer accounts (e.g., storing customer accounts and properties), manage company accounts (e.g., storing company accounts and properties), manage transaction histories (e.g., storing financial transaction details), store customer profiles, storing dictionaries used by the mobile wallet platform, such as, for example, countries, currencies, etc., and managing money containers. Rules engine 109 is configured to gather financial transaction statistics and uses the statistics to provide transaction properties, such as, for example, fees and bonuses. Rules engine 109 is also configured to enforce business constraints, such as, for example, transactions and platform license constraints.

Name matching engine 110 is configured to match different objects according to specified configuration rules. Matching engine 110 can be used to find similarities between names, addresses, etc. Transaction processor 121 is configured to manage financial accounts and transactions. The transaction processor 121 can be used to hold, load, withdraw and deposit funds to mobile wallet accounts. Transaction processor 121 can also be used as a common interface to a third party processor system. When used as a common interface, financial operations may be delegated to the external processor. A Clearing House subsystem of transaction processor 121 can be used to exchange the financial information with a bank.

Components of a mobile wallet platform can be connected to one another over (or be part of) a system bus and/or a network. Networks can include a Local Area Network (“LAN”), a Wide Area Network (“WAN”), and even the Internet. Accordingly, components of the mobile wallet platform can be “in the cloud”. As such, mobile wallet platform components as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the system bus and/or network.

The components depicted in FIG. 1 can interoperate to provide a number of financial and other services including but not limited to enrolling a customer for a mobile wallet, adding a stored value account (either hosted by a mobile wallet platform or a third party), adding a bank or credit union account to a mobile wallet, adding a debit or credit card account to a mobile wallet, depositing funds in a mobile wallet, withdrawing funds from a mobile wallet, paying bills from a mobile wallet, topping up a prepaid mobile account through a mobile wallet, transferring funds through a mobile wallet (nationally or internationally), making in-store purchases using a mobile wallet, and various other tasks as described herein below.

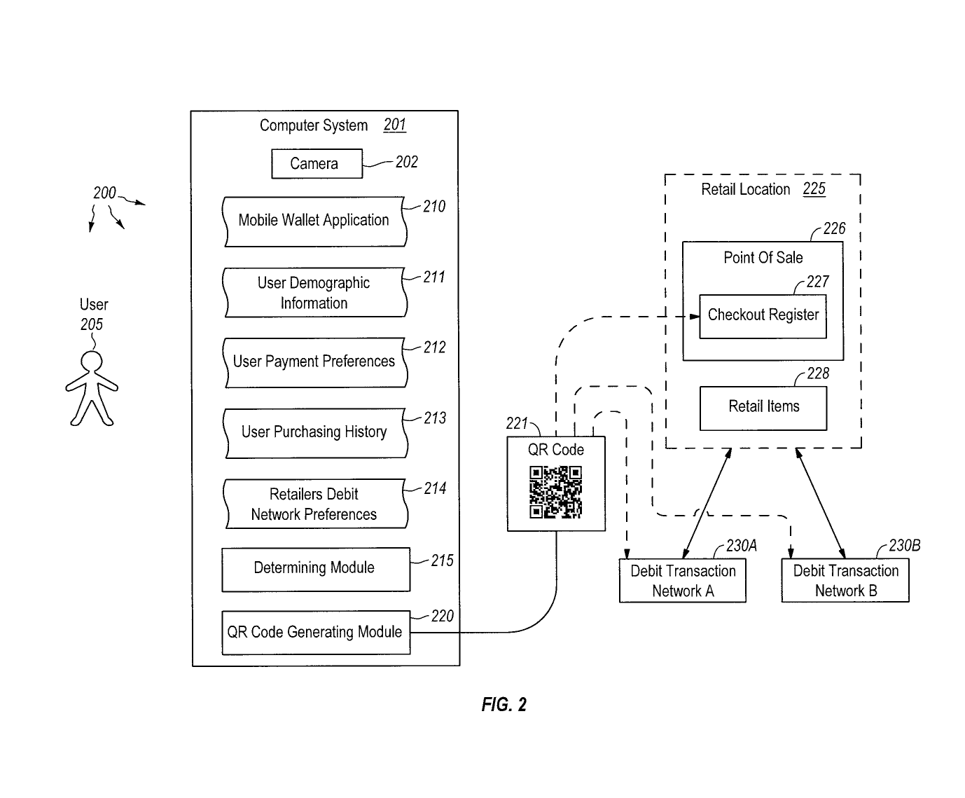

The telephone, smartphone, tablet or other computing system that interacts with the mobile payment system typically includes a camera, image sensor, image scanner or other hardware that allows a user to scan or capture an image. For instance, as shown in environment 200 of FIG. 2, computer system 201 may include a camera 202. The computer system 201 may include a telephone, smartphone, feature phone (i.e. a non-smart phone), tablet, laptop, smart watch or other type of mobile computing system. Each type of computer system may be a general-purpose or special-purpose computer system as described above, and may include one or more processors and memory. The user of the phone 201 (i.e. user/customer 205) may thus point the camera 202 or other hardware at an object such as a can of soup and either take a picture of the object, or allow software to scan the image using the camera. Software on the phone or tablet 201 then performs a local search or consults a database (e.g. over the internet) to retrieve information related to that item or product including coupons or price discounts.

In addition to receiving product information and discounts, the user 205 may also use their phone 201 or other device to pay for the items they wish to buy. In one embodiment, a customer may be at a retail location 225 shopping for various items 228. Once the customer 205 has finished shopping, he or she proceeds to the checkout area. The checkout area includes a point of sale 226 with a checkout register 227 that typically accepts cash, debit or credit cards as payment. The checkout register 227 may also be configured to allow users to pay using a mobile wallet. Accordingly, the customer may use a mobile wallet application 210 on a smartphone (e.g. 201), tablet or other computer system to pay for the items.

When paying for the items 228, the determining module 215 of user's digital device 201 may determine that the user 205 is attempting to use their mobile wallet application 210 to pay for the items. The mobile wallet application may use various types of information to determine which debit network (e.g. 230A or 230B) is to be used to process the payment transaction. As will be understood by one skilled in the art, various different debit networks exist for processing debit transactions (e.g. Star or NYCE). These debit networks conduct the transactions between the retailer's bank and the customer's bank that allow the user to pay for items using a debit card linked to their own checking (or other type of) account.

In some cases, the decision as to which debit network to use for a given transaction will be based on either the customer's demographic information, the customer's payment preferences or the customer's purchasing history. In some cases, for example, the user 205 may provide demographic information 211 to the mobile wallet application 210 indicating age or age range, income or income range, general housing location and other similar information. This information may be used, at least in some cases, to provide targeted advertisements, promotions or coupons to the user via the mobile wallet. The user's demographic information 211 may provide indications or other clues that the user may prefer one debit network over another (e.g. for cost reasons, or convenience reasons). Accordingly, this information may be used by determining module 215 when determining which debit network to use for a given transaction.

Similarly, user payment preferences 212 and/or user purchasing history 213 for user 205 may be used to determine which debit network to use for a debit transaction. For example, if the user has indicated in their payment preferences which debit network to use, that information may be provided to the determining module 215. Moreover, if the user's purchasing history indicates that a specified debit network has been used in all or most of the user's debit transactions, that information could also be used by the determining module 215 when making its decision as to which debit network to use. The decision as to which debit network to use may be based on any one of the user's demographic information 211, the user's payment preferences 212 or the user's purchasing history 213, or a combination thereof.

Still further, other factors may be taken into account when determining which debit network to use. For instance, the decision may also be based on the retailer's preferences. For example, different retailers may prefer to use certain debit networks due to various factors including pricing. Thus, retail location 225 may prefer to use debit network 230A over debit network 230B because debit network 230A charges less per debit transaction. Or, the retail location may specify that they prefer to use different debit networks at different times of the day, or may specify that they prefer to use different debit networks at their East Coast and West Coast branches. Accordingly, a retailer may specify preferences that vary based on different factors. In some embodiments, these preferences may be broadcast to users' mobile wallet applications while they are shopping at the store.

Thus, in this manner, based on customer information (e.g. 211-213) and/or the retailer's preferences 214, the user's mobile wallet application 210 may determine which debit network is to be used to route the user's transaction. Once it has been determined which debit network is going to be used, a QR code 221 may be generated by module 220 with the debit network selection embedded therein. This QR code 221 may then be presented to the retailer when making the purchase. The QR code has each of the necessary transaction details embedded therein, and also indicates on which debit network the transaction is to take place. In some cases, the QR code may link directly to the selected debit network (as indicated by the dotted arrow lines to debit networks 230A and 230B). In such cases, the user may route their payment for merchandise directly to the debit network using their mobile wallet.

The QR code 221 may be a secure, tokenized QR code that fully represents the details of the user's purchase, along with an indication of which debit network has been specified for that transaction. This QR code is scannable by the checkout register 227 and, as a result of the scan, provides a debit network selection (e.g. debit network 230A, 230B or some other debit network) through which the transaction is to be processed.

The debit network selection may be determined dynamically for each customer. Thus, each customer may use a different debit network to process their transactions. Moreover, the debit network selection may be determined dynamically for each retailer. Thus, as with customers, each retailer may specify a certain debit network that is to be used when debit transactions take place. In some cases, the retailer's preference for debit network may take precedence over the user's preferences or buying history. The debit network selection may also be chosen based on the location (e.g. 225) at which the payment is initiated. For instance, if the customer 205 is purchasing an item in a store on the West Coast, debit network 230A may be used, while if the user is purchasing an item from a store located on the East Coast, debit network 230B may be used. Still further, different debit networks may be used based on the time of day at which the payment is initiated, based on the per-transaction costs, based on initiation or other fees or based on any other criteria established by the retailer or by the user.

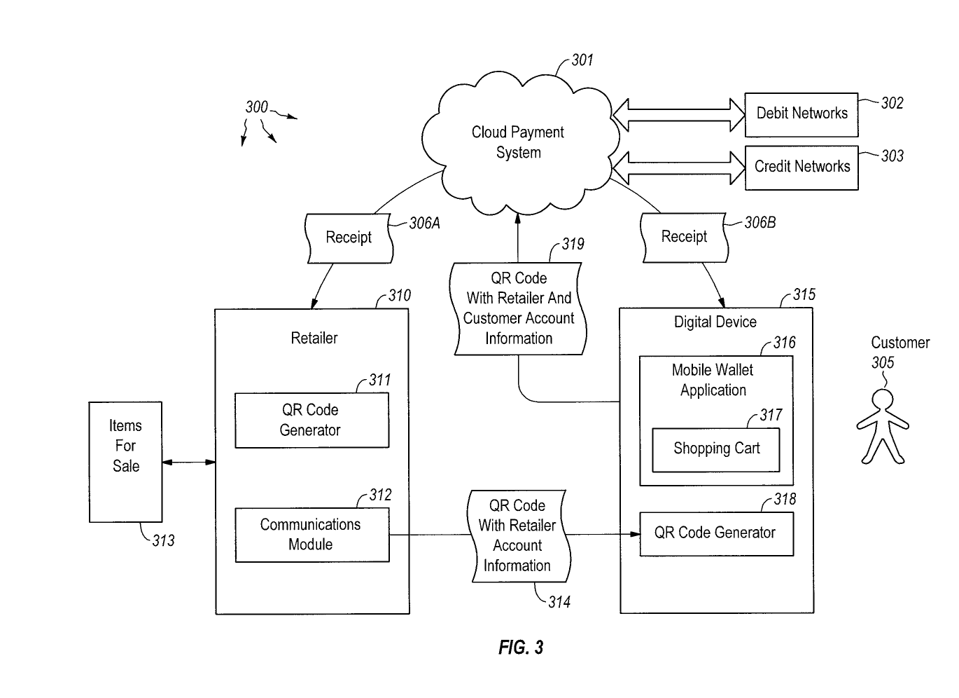

Accordingly, methods, systems and computer program products are provided which select a debit network using a QR code. Embodiments allow users to purchase items using a mobile wallet that is linked to a debit account. Based on the user's purchase history or demographic information and based on the retailer's preference, the customer may generate a QR code which specifies the debit network to use when processing the customer's debit transaction. The QR code includes account information as well as the selection of debit network that is to be used to process the transaction. In this manner, a retailer may specify which debit network is to be used when processing debit transactions. Other embodiments will be described with regard to FIG. 3 below.

FIG. 3 illustrates a transaction environment 300 in which various monetary transactions may be performed. Various embodiments will be described, chiefly from the perspectives of the following entities: the cloud payment system, the customer's digital device and the retailer's computing system.

The first embodiment described will be from the perspective of the cloud payment system 301. The cloud payment system may incorporate both private and public clouds. The clouds may include one or more processing units. These processing units may include CPU's and system memory. The processing units may be configured to run software or virtual machines that, themselves, run software. The software may be configured to process transactions between retailers and customers. For example, as shown in FIG. 3, the cloud payment system 301 may process a transaction between retailer 310 and customer 305. The retailer may offer goods or services for sale (e.g. items for sale 313). The customer 305 may desire to purchase one or more of these goods or services. This transaction will now be described from the reference point of the cloud computing system 301.

The cloud payment system 301 may receive from customer 305 a tokenized QR code 319. The QR code indicates that the customer is attempting to use a mobile wallet application 316 to pay for one or more items 313 sold by the retailer 310. The tokenized QR code 319 includes embedded account information for both the retailer and the customer. The account information may include bank account information, credit card information, deposit account information or other transaction related information. In some cases, the account information may also include an indication of which debit network 302 or credit network 303 is to be used to process the transaction. As indicated above, the debit or credit network selection may be chosen based on time of day at which the payment is initiated, or may be made based on other criteria such as cost per transaction.

The customer's tokenized QR code 319 may be generated by a mobile wallet application 316 running on a digital device 315 such as a cell phone, tablet, laptop or other computing device. The mobile wallet application may allow the customer to pay for items using their phone using the mobile wallet platform described in FIG. 1 above. The QR code generated by the mobile wallet application may indicate the amount of money that is to be transferred from the customer to the retailer as part of the transaction. The cloud payment system 301 may then use that information to conduct the transaction. The payment network used to process the transaction may be determined based on customer information and/or retailer preference. Once determined, the account information received in the tokenized QR code may be used to route the customer's payment and account details.

Once the amount of money has been determined, and the proper payment network has been selected (e.g. 302 or 303), the money may be transferred from the customer's account to the retailer's account. An electronic receipt may be sent by the cloud payment system to the retailer (receipt 306A) and to the customer (receipt 306B). In some cases, before the transaction is processed, the cloud payment system may determine whether any discounts or loyalty points are to be applied to the customer's transaction to reduce the amount of the transaction. These discounts or loyalty points may be based on the customer's previous transactions, which may include the customer's shopping history at that retailer's store(s). If the cloud payment system 301 determines that discounts or loyalty points do apply to the transaction, the cloud payment system may apply the discounts or loyalty points to the transaction to reduce the amount accordingly.

The next embodiment will be described from the perspective of the digital device 315 (i.e. from the customer 305). Because the customer owns and/or implements the digital device 315, this embodiment will refer to the digital device 315 and the customer 305 interchangeably. The customer receives from retailer 310 a tokenized QR code 314 corresponding to the retailer. The tokenized QR code includes embedded account information for the retailer for use in processing transactions with the retailer. As with the example above, the QR code may include bank account information, information about the retailer's store including name, location, store number, etc. or other information that may be used in a transaction. The information may be tokenized and securely embedded within the QR code 314.

The customer may receive this QR code automatically upon entering the retailer's store, or may receive it as a result of a request for such a QR code. The receipt of the retailer's QR code 314 may initiate changes to the user's mobile wallet application 316 and/or to the shopping cart functionality 317. For instance, upon receiving a QR code from the retailer 310, the mobile wallet application 316 interface may be changed to have the look and feel of the retailer including the retailer's logo, color scheme, or other trade dress. The functionality of the mobile wallet may also be changed as desired by the retailer. In some cases, the customer may have the option to refuse any such changes pushed by the retailer.

The mobile wallet application 316 may have access to camera features available on the digital device 315. These camera features may be used to scan items while the user is browsing through the store. Accordingly, at least in some embodiments, the customer 305 may scan items with their digital device (e.g. by scanning the item's bar code) and have those items stored in the shopping cart 317. Accordingly, the digital device may receive and store digital representations of retail items in the shopping cart 317 running in the mobile wallet application 316.

Once the customer indicates that they are finished shopping and wish to pay for the scanned items, the mobile wallet application 316 may determine the sum total of the price of each scanned item. The QR code generator 318 may then generate a second, different tokenized QR code (i.e. QR code 319) that includes the customer's account information, the determined sum total for the transaction, and the retailer's account information. This QR code 319 may then be sent to the cloud payment system 301 for processing. Upon completion of the transaction, the digital device may receive an electronic receipt 306B indicating that the transaction was successfully processed. The electronic receipt may indicate each of the paid-for items, and may be stored in a data store provided by the mobile wallet application 316.

Embodiments of the transaction system shown in FIG. 3 will now be described from the perspective of the retailer 310. The retailer may have some type of computer system capable of processing software and further capable of transmitting and receiving data, either wirelessly or over a wired connection. The QR code generator 311 of the retailer's computer system may generate a tokenized QR code 314 that includes embedded account information of the retailer that can be used by other entities when processing transactions with the retailer.

The retailer 310 may receive a request from customer 305 indicating that the customer intends to initiate a transaction to pay for various items owned by the retailer. The communications module 312 of the retailer's computer system may send the generated tokenized QR code 314 to the customer 305, where it is received at the mobile wallet application 316 running on a mobile digital device 315 of the customer. Then, after the customer has sent the updated QR code 319 with the transaction total, the customer's account information and the retailer's account information, and after the transaction has been processed, the retailer may receive an electronic receipt of the transaction, indicating which of the retailer's items were paid for by the customer using the customer's mobile wallet application. Notably, the retailer's computer system does not need a typical point of sale device such as a credit card reader or debit card reader. Indeed, for the transactions described in FIG. 3, the retailer does not even need a cash register. The retailer only needs a computing device capable of communication with the cloud payment system 301.

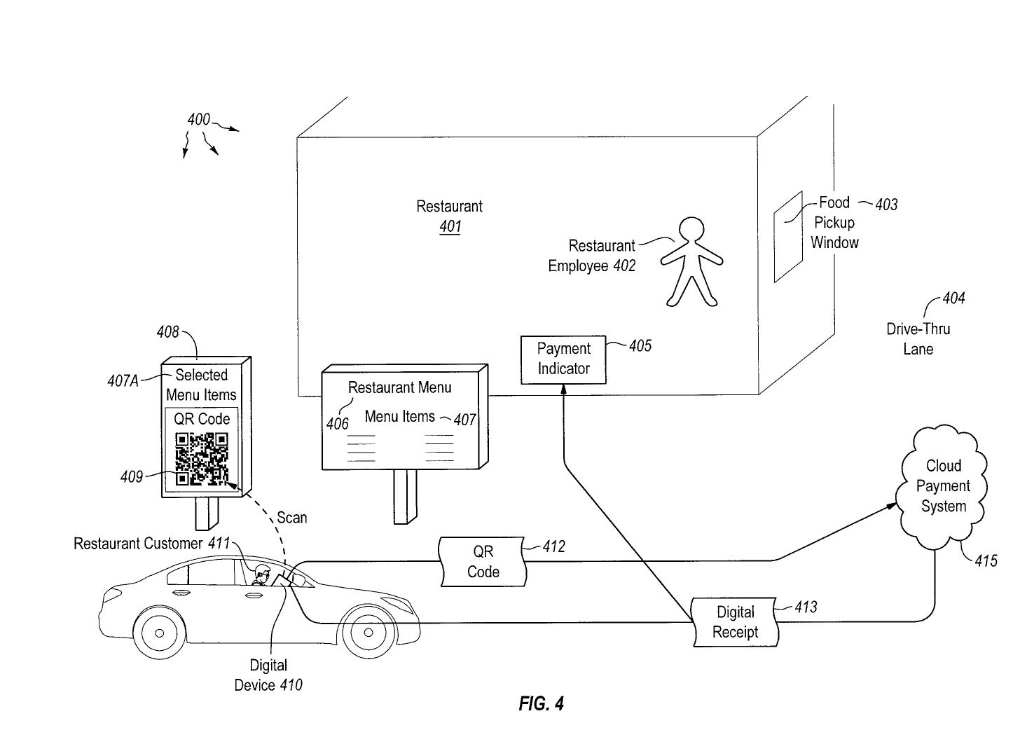

In another embodiment, as shown in environment 400 of FIG. 4, a user conducts a transaction with a restaurant using QR codes. Although environment 400 is shown a fast-food restaurant with a drive-through window, the principles and techniques described may apply to any type of restaurant including low-end, mid-range and high-priced restaurants. These principles and techniques may also be applied to other retail establishments including dry cleaning establishments or any other retailers that wish to quickly conduct transactions.

The environment 400 of FIG. 4 shows a restaurant 401 that has one or more restaurant employees 402. As mentioned above, the restaurant may be any type of restaurant, including a fast-food restaurant that has a drive-thru lane 404 and a food pickup window. As is customary with such restaurants, an outdoor menu 406 may be provided which lists the restaurant's menu items 407. The restaurant customer 411 may drive up to the menu 406 and speak to a restaurant employee 402 through an intercom or other similar system. The restaurant employee 402 may enter the restaurant customer's selected menu items 407A into a computer system. These selected items may be displayed on an outdoor display screen 408. The display screen may also be configured to display a QR code, along with the selected menu items.

As explained above with regard to FIG. 3, the restaurant may generate the QR code 409 that is to be scanned by the customer 411. The QR code may include the restaurant's account information encrypted within the QR code. The QR code 409 may further include a list of the menu items 407A selected by the customer 411, as well as an indication of which payment network they prefer to use. For example, the QR code may indicate a specific debit network 302 or credit network 303 they prefer to use when processing debit or credit transactions. All of this information may be embedded into the QR code that is presented on the outdoor display screen 408.

The displayed QR code generated by the restaurant may then be scanned by the customer 411 using their cellular phone or other digital device 410. The customer's digital device (e.g. 315 of FIG. 3) can use its own QR code generator 318 to generate a second QR code 412 that includes some or all of the information contained in the QR code generated by the restaurant 409. The second QR code 412 thus includes the restaurant's account information, an indication of the menu items ordered, the total price, an indication of the restaurant's preferred payment network, and the customer's account information for payment of the total price. The customer's account information corresponds to one of the customer's debit or credit accounts. The user may select any of their accounts for payment. The cloud payment system 415 may then select a debit or credit network for processing based on the restaurant's preference (as indicated in the QR code).

Once the second QR code has been generated, the customer's digital device 410 may send the second QR code 412 to the cloud payment system 415. The cloud payment system may decrypt the embedded, encrypted information including the restaurant's account information, the restaurant customer's account information, the menu items being purchased, and an indication of which debit or credit network is preferred for processing the customer's payment. The cloud payment system 415 then processes the transaction between the customer's debit or credit card provider and the restaurant's commercial bank or other account, as explained above with regard to FIG. 3.

Once the transaction has been processed, the cloud payment system 415 generates a digital receipt that is wirelessly transmitted to both the customer's digital device 410 and to the restaurant 401. The digital receipt 413 indicates that the customer 411 has paid for the selected menu items 107A, and may further list which items have been paid for. The restaurant 401 may have a payment indicator 405 which is configured to receive digital communications such as digital receipt 413 and indicate to the restaurant employees 402 that the customer's transaction has gone through. The payment indicator may include a display screen, a flashing light or any other indicator that would indicate that the customer's transaction has cleared. The restaurant employee may then proceed to give the customer their selected menu items.

Thus, as with the retail scenarios described with reference to FIG. 3, a user in FIG. 4 may use the established system to conduct a transaction with the restaurant without ever swiping a debit or credit card, or paying with cash. Indeed, for such transactions, the restaurant does not need a typical point of sale device such as a credit card reader or debit card reader. For the transactions described in FIG. 4, the restaurant does not even need a cash register. The restaurant only needs a computing device capable of communication with the cloud payment system 415. The customer can order their food, scan the QR code 409, (automatically) transmit a new QR code 412 that has their account information in addition to the restaurant's, and receive a receipt indicating that the transaction has gone through and that the food has been paid for. The user can then proceed directly to the food pickup window, receive their food and drive away.

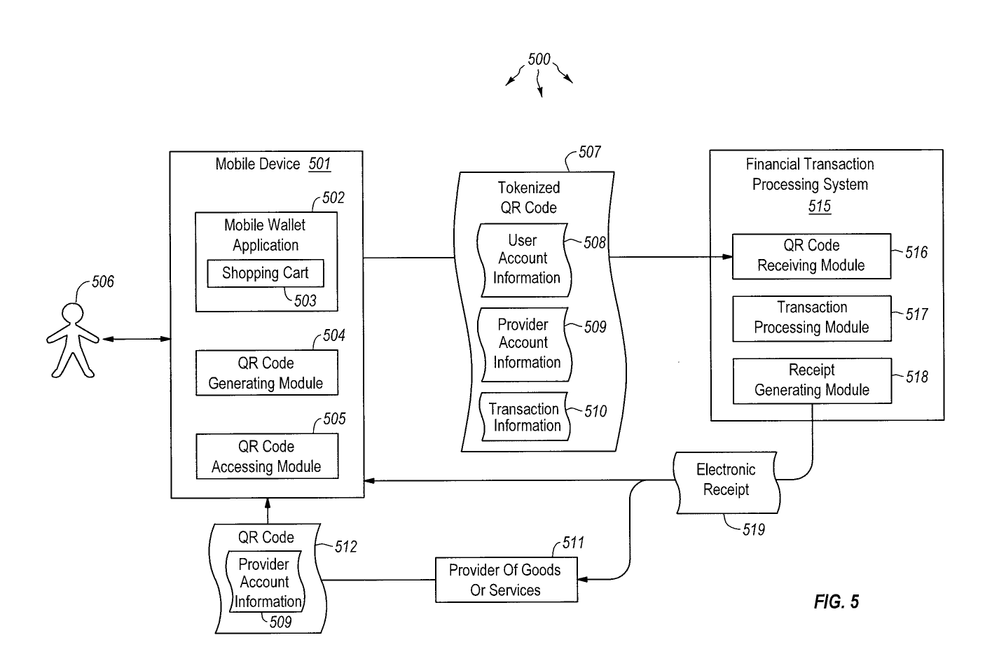

Further embodiments are now described in conjunction with FIG. 5. The computing architecture 500 of FIG. 5 allows a user 506 to directly purchase items from a provider using a quick response (QR) code. These items may be physical or electronic goods, services or other items. The provider of the goods or services 511 may be any type of producer, seller or other provider of goods or services. For example, the provider 511 may be a grocery or other retail store. Alternatively, the provider 511 may be a consumer packaged goods (CPGs) producer. Still further, the provider 511 may be a media producer that produces movies, songs, applications or other electronic media. Any such provider may allow their goods or services to be purchased (or rented) using a QR code 512.

As explained above, the QR code 512 may be a tokenized QR code that is encrypted with various portions of information. For example, the QR code 512 provided by the provider in conjunction with a particular good or service may include the price of the good or service, and may also include the provider's account information 509 in an encrypted form. The account information may link to debit, credit or other accounts that the provider may use to receive payment for the good or service. The QR code 512 may be provided to the user (i.e. to the user's mobile device 501) in a variety of different manners. For instance, the QR code 512 may be printed alongside an advertisement associated with the good or service. Additionally or alternatively, the QR code 512 may be displayed on a website or in an application in conjunction with the good or service. Regardless of where the QR code 512 is displayed, the code may be scanned by the user and accessed by the QR code accessing module 505.

The QR code accessing module 505 may read and interpret the provider's QR code 512 to extract the pricing, product or other information. In most embodiments, the provider's account information 509 will remain in encrypted form. The good or service may be placed in the user's shopping cart 503 within their mobile wallet application 502, or may be purchased directly without being placed in a shopping cart. When the user 506 desires to pay for the good or service, the QR code generating module 504 on the mobile device 501 may generate a new tokenized QR code 507 that includes not only the provider's encrypted account information 509 and the transaction information 510 (selected product, price, location, time, loyalty points, rewards, coupons, etc.), but also the user's encrypted account information 508. This QR code is then sent to the QR code receiving module 516 of the financial transaction processing system 515.

The financial transaction processing system 515 may be any type of local or distributed (i.e. cloud) computing system. The financial transaction processing system 515 may be communicatively connected to debit networks, credit networks, banks or other financial institutions or systems. The transaction processing module 517 of the financial transaction processing system 515 may process the transaction identified by the QR code 507 using the user's account information 508, the provider's account information 509 and the corresponding transaction information 510. Once the transaction has been processed using the appropriate payment network(s), the receipt generating module 518 of the financial transaction processing system 515 generates an electronic receipt 519 that is sent to the user 506 (i.e. to the user's mobile device 501) and the goods/services provider 511. Once the receipt of payment has been received, the provider can relinquish the purchased good or service. In this manner, a user can directly purchase a good or service using a QR code. Further embodiments will be described below.

In one embodiment as seen from the financial transaction processing system's point of view, the financial transaction processing system 515 may receive from user 506 a tokenized QR code 507 indicating that the user has initiated a financial transaction using a mobile wallet application 502 to pay for one or more items sold by a provider 511. The tokenized QR code 507 includes embedded account information for both the provider (i.e. account information 509) and the user (i.e. financial account information 508). The transaction processing system 515 may determine from the tokenized QR code the amount of money that is to be transferred from the user 506 to the provider 511 as part of the financial transaction.

The financial transaction processing system 515 may also determine which of the user's stored value accounts is to be used to pay for the one or more items provided by the provider 511. The stored value accounts may include checking or savings accounts, credit accounts, prepaid debit accounts or other stored value accounts. The financial transaction processing system 515 may then transfer the determined amount of money from the determined stored value account to the provider's account (as indicated by the encrypted account information 509 embedded in QR code 507) and send an electronic receipt 519 of the financial transaction to the user 506 and the provider 511.

As mentioned above, the user may use a QR code to pay for (or rent) substantially any type of good or service. The goods or services may, for instance, include media items. In such cases, the provider of the media items may be the actual producer of the media items. As such, a media producer could sell their media directly to a user using QR codes. Middle-men sellers or platforms would not be needed in such scenarios. The media items may include songs, movies, video games, applications, ringtones or other forms of media. In other cases, the items provided by the provider 511 may include consumer packaged goods (CPGs). In such cases, the provider may be a CPG producer. In this manner, a CPG producer may be able to sell their goods directly to consumers such as user 506 using QR codes. Still further, providers of services, such as web site hosting, may be able to sell their services directly to consumers without having to go through a clearing house or other middle man.

In some embodiments, loyalty points or rewards may be factored into the transaction. The financial transaction processing system 515 may determine that various discounts or loyalty points are to be applied to the financial transaction to reduce the amount of the financial transaction by a specified amount (or even make the item free). The financial transaction processing system 515 may then apply the discounts or loyalty points to the transaction to reduce the amount of the transaction by the specified amount. This determination may include accessing the user's purchasing history with that provider. If the user has a long purchasing history with that provider, the provider may choose to apply discounts or loyalty points to reduce the price of the goods or services being purchased. In some cases, the provider may specify which payment network (e.g. debit or credit network) is to be used to route the transactions through.

In another embodiment, described now from user 506's perspective, the QR code accessing module 505 of the user's mobile device 501 may receive from a provider 511 a tokenized QR code 512 corresponding to the provider. The tokenized QR code includes embedded account information for the provider for use in processing financial transactions with the provider (e.g. bank or credit account, transaction-specific information, etc.). The QR code accessing module 505 may determine from the QR code 512, or the user may separately receive an indication of which items provided by the provider are to be added to a shopping cart 503 running in a mobile wallet application 502. These items may be selected by the user by scanning the QR code provided by the provider (i.e. QR code 512).

The mobile wallet application 502 may determine the sum total of the price of each selected item, and the QR code generating module 504 may generate a second, different tokenized QR code 507 that includes the user's account information 508, the determined sum total 510 and the provider's account information 509. In some cases, the QR code 507 may be generated by the mobile wallet application 502 running on the mobile device 501. The tokenized QR code may then be sent to the financial transaction processing system 515 and, after the transaction has been processed, the mobile device 501 may receive an electronic receipt 519 indicating that the financial transaction was processed. The electronic receipt may list each of the items that were paid for during the transaction.

Still further, in an embodiment described from the provider's perspective, the provider may be able to directly sell items using a QR code. The provider 511 may generate a tokenized QR code 512 that includes embedded (and encrypted) account information of the provider for use in processing transactions with the provider. The provider 511 may receive a request from a user 506 indicating that the user intends to initiate a financial transaction to pay for various selected items provided by the provider. The provider 511 then sends the generated tokenized QR code to the user 506. As such, the tokenized QR code may be received at a mobile wallet application running on a mobile digital device 501 of the user 506. After the transaction has been processed, the provider 511 may then receive an electronic receipt 519 of the transaction. As above, the receipt may provide an indication of which items were paid for by the user using the QR code and the mobile wallet application. In this manner, providers may sell and users may buy directly from providers using QR codes.

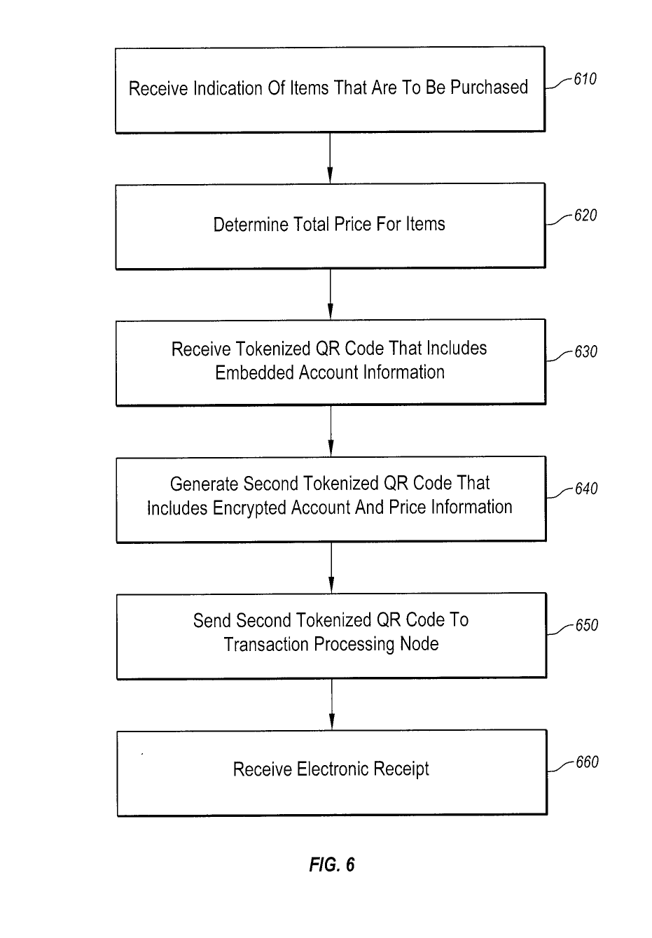

In view of the systems and architectures described above, methodologies that may be implemented in accordance with the disclosed subject matter will be better appreciated with reference to the flow charts of FIGS. 6, 7 and 8. For purposes of simplicity of explanation, the methodologies are shown and described as a series of blocks. However it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 6 illustrates a flowchart of a method 600 for performing a transaction using a quick response (QR) code. The method 600 may be performed on a computer system that has one or more processors, memory, and one or more computer-readable storage media having stored thereon computer-executable instructions that, when executed by the one or more processors, causes the computing system to perform the method 600. The method 600 will now be described with frequent reference to the components and data of environment 500 of FIG. 5.

Method 600 includes receiving, from a purchaser, an indication of one or more items that are to be purchased using a mobile wallet application (610). For example, financial transaction processing system 515 (or cloud payment system 301 of FIG. 3) may receive transaction information 510 individually or as part of tokenized QR code 517. The transaction information 510 includes an indication of those items that are to be purchased using mobile wallet application 502. The transaction information 510 lists those items that the user 506 has selected for purchase, along with associated prices for each item. The QR code receiving module 516 (or another receiving module) of the financial transaction processing system 515 may receive the transaction information 510 (individually or as part of tokenized QR code 507). The transaction processing module 517 may then determine a total price for those items that are to be purchased (620).

Whether the transaction information 510 is sent individually, or as part of a tokenized QR code 507, the QR code may be sent to the financial transaction processing system. The QR code may include embedded account information for the purchaser 506 for use in processing transactions with sellers (630), in addition to provider/seller account information and/or transaction information 510 (if not sent individually). It should be noted that substantially any amount or type of information may be embedded into the tokenized QR code 507. Furthermore, it should be noted that the tokenized QR code may be sent to other nodes or computer systems before being sent to the financial transaction processing system. For example, the tokenized QR code may be sent to a retailer's computer system that is configured to process transactions. In one embodiment, a retailer or other provider of goods or services 511 may send a QR code 512 to a purchaser 506 that includes the retailer's encrypted account information 509. The purchaser (or, more specifically, the purchaser's mobile wallet application 502) may then embed the provider's account information 509 into the tokenized QR code 507.

In some embodiments, a provider of goods or services 511 may receive an indication of goods or services that are to be purchased (individually or as part of a QR code). The provider's computer system may access the indication of goods and the purchaser's account information 508 which was embedded in the QR code. The retailer's computer system may then generate a second, different tokenized QR code that includes encrypted account information for the seller 509, along with encrypted account information for the purchaser 508 and the determined total price for the items that are to be purchased 510 (640). This second tokenized QR code may then be sent to a transaction processing node (e.g. 515), where the transaction processing node transfers money equivalent to the determined total price from the purchaser's account to the seller's account according to the encrypted account information in the second tokenized QR code (650). The financial transaction processing system 515 then sends electronic receipt 519 to the purchaser 506 and the seller 511 (660).

In some cases, the financial transaction processing system 515 may determine that discounts or loyalty points are to be applied to the purchaser's transaction to reduce the amount of the transaction, and may apply the discounts or loyalty points to the transaction to reduce the amount of the transaction by a specified amount. Determining the number or type of discounts or loyalty points that are to be applied to the purchaser's transaction may include determining the purchaser's purchasing history, especially pertaining to the provider's goods and services. If the purchaser qualifies for discounts or loyalty points based on the purchaser's purchasing history, they may be applied automatically by the transaction processing module 517. In some cases, the seller 511 may be able to specify which payment network is to be used to route monetary transactions through. The seller may specify certain payment networks for certain times of the day, for certain store locations, for certain customer locations, or based on other criteria such as cost to the seller.

The QR code received from the purchaser may be generated by the purchaser's mobile wallet application after, for example, the user scans or selects items they wish to purchase. In one case, the purchaser may scan physical items that are to be purchased using a scanning application on the mobile device 501, using a hardware scanner or other scanning means. In this manner, the scanned items are added to a shopping cart running in the mobile wallet application and can be purchased using the tokenized QR code 507. Once the item has been paid for, the financial transaction processing system 515 may send an electronic receipt to the mobile wallet application 502 of the purchaser, as well as one to the seller. The electronic receipt may include a listing of those items sold/purchased, along with an indication of the price paid, taxes paid, loyalty points used and/or accrued and other information.

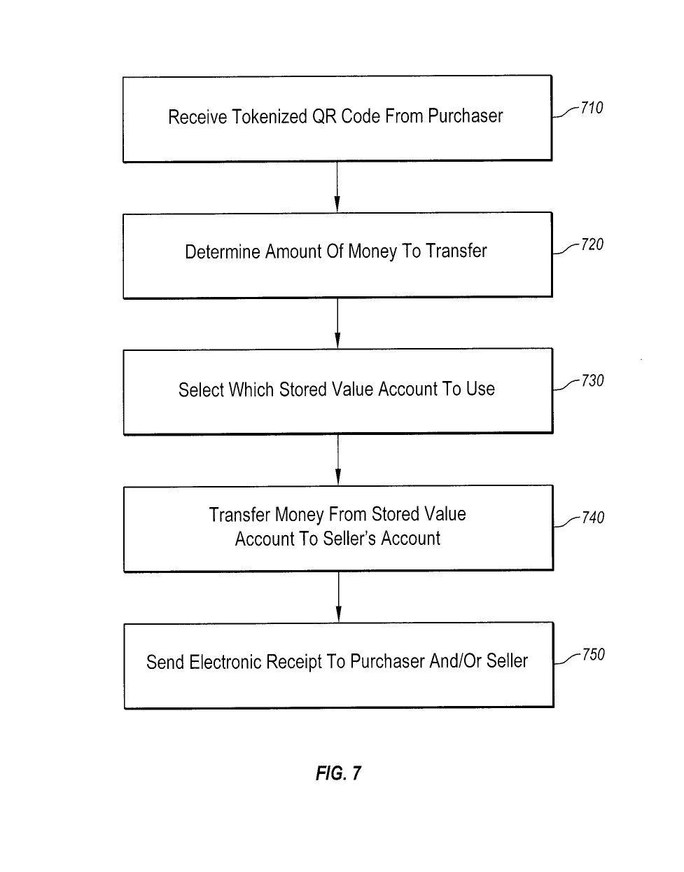

Turning now to FIG. 7, a flowchart of a method 700 is illustrated for directly purchasing items from a seller using a QR code. The method 700 will now be described with frequent reference to the components and data of environment 500 of FIG. 5.

Method 700 includes receiving from a purchaser a tokenized QR code indicating that the purchaser has initiated a financial transaction using a mobile wallet application to pay for one or more items sold by a seller, the tokenized QR code including embedded account information for both the seller and the purchaser (710). For example, purchaser 506 may send tokenized QR code 507 to the financial transaction processing system 515, indicating that they wish to conduct a monetary transaction. The monetary transaction may be to pay for goods or services provided by provider 511.

The financial transaction processing system 515 may determine, from the tokenized QR code 507, the amount of money that is to be transferred from the purchaser to the seller as part of the financial transaction (720), and may select which of one or more stored value accounts belonging to the purchaser are to be used to pay for the items provided for sale by the seller (730). The purchaser may, for example, have multiple different checking, savings, credit or other stored value accounts from which to draw funds to pay for a purchase. The financial transaction processing system 515 may then transfer the determined amount of money from the selected stored value accounts to the seller's account, using the embedded account information 509 provided in the tokenized QR code (740). Then, once the money has been transferred, the financial transaction processing system 515 may send an electronic receipt of the financial transaction to the purchaser and/or the seller (750).

The goods or services provided by provider 511 may be any type of goods or services. In some cases, the goods may be media items, and the seller may be a media producer. Thus, a media producer or reseller may be able to sell media items such as songs, movies, games, ringtones, pictures or other items directly to purchasers using a QR code. Similarly, producers or resellers of consumer packaged goods (CPGs) may be able to sell CPGs directly to consumers using QR codes. Media producers, CPG producers or other sellers may each specify which payment network is to be used to route the purchaser's transaction through.

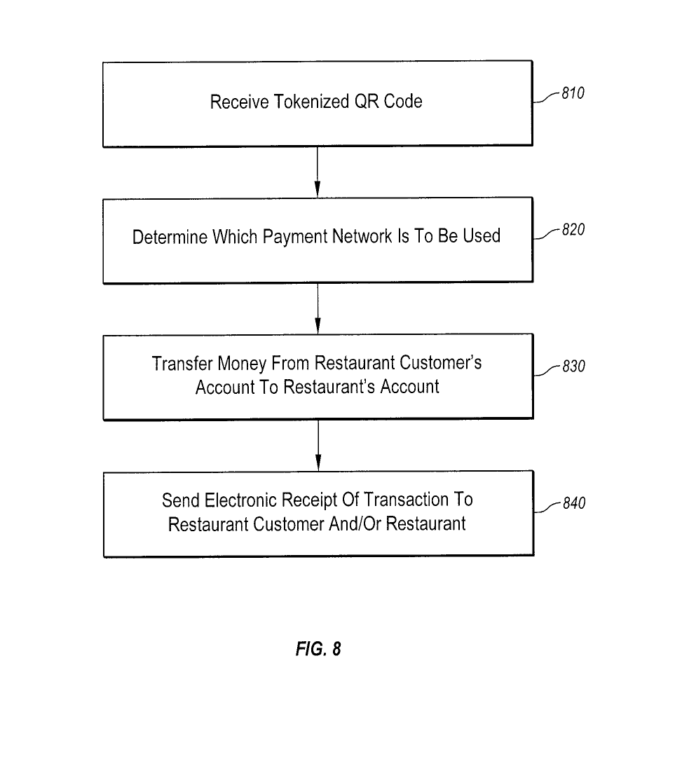

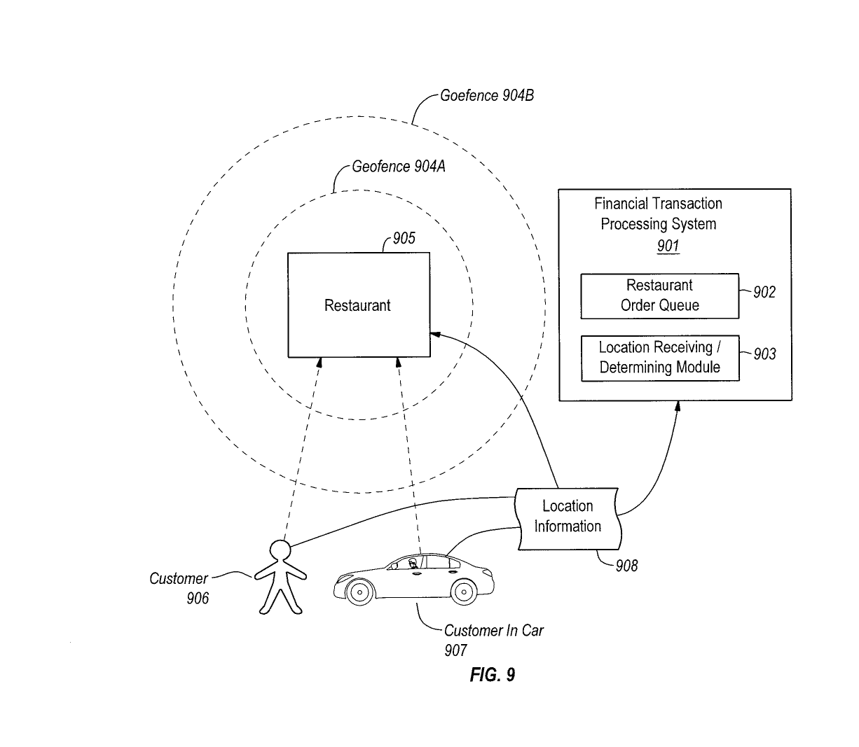

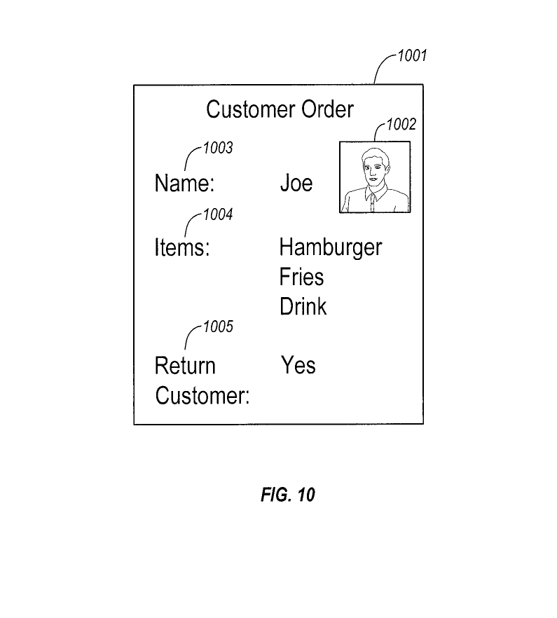

Turning now to FIG. 8, a flowchart of a method 800 is illustrated for performing a transaction at a restaurant using a quick response (QR) code. The method 800 will now be described with frequent reference to the components and data of environment 400 of FIG. 4, and FIGS. 9 and 10.

Method 800 includes receiving from a restaurant customer a tokenized QR code indicating that the restaurant customer is using a mobile wallet application to pay for one or more menu items sold by the restaurant, the tokenized QR code including embedded account information for both the restaurant and the restaurant customer, an indication of which menu items are being purchased, an indication of the total amount due, and an indication of payment instructions for the restaurant (810). Thus, restaurant customer 411 may send QR code 412 to cloud payment system 415, indicating that the customer wants to make a purchase at restaurant 401. The QR code includes (encrypted) embedded account information for the customer and for the restaurant (obtained, for example, by scanning a QR code 409 presented by a display 408 in a drive-thru menu. The QR code 412 includes an indication of the customer's selected menu items 407A.

The cloud payment system 415 determines which payment network is to be used to pay for the selected menu items (820), transfers the money indicated in the total amount due to from the restaurant customer's account to the restaurant's account (830), and sends an electronic receipt of the transaction to the restaurant customer and/or the restaurant (840). The cloud payment system 415 may further determine that various discounts or loyalty points are to be applied to the restaurant customer's transaction to reduce the amount of the transaction. If such discounts, loyalty points or coupons are determined to apply, the cloud payment system may apply the discounts to the transaction to reduce the amount of the transaction and/or accrue or decrement loyalty points for the customer. The user may qualify for and collect such loyalty points by frequently purchasing items at that restaurant. As with the other examples described herein, the restaurant may indicate to the cloud payment system which payment network is to be used to pay for the selected menu items. Alternatively, the restaurant customer may be able to select which payment network is used.

As mentioned above, the restaurant may receive an electronic receipt indicating that the customer has indeed paid for their items. The electronic receipt may come in various forms and may encompass any type of electronic notification including a text message, an email message, a notification, a picture of a receipt, a media representation of a receipt or any other kind of electronic notification. The electronic receipt may provide the restaurant a means of reconciling and settling funds at the end of the day.

For example, an end-of-day receipt may be generated which indicates the total number of transactions processed using QR codes and mobile wallets. The end-of-day receipt may list each transaction individually for review. If a user was mistakenly charge the wrong amount for an item, a restaurant worker may be able to edit the amount to the correct amount and refund the user (if they overpaid for that item). Once the funds have been reconciled for that day or shift or other time period, the transactions of that day may be executed to denote that each has been reconciled.

At the end of the reconcilement process, a marker may be inserted into the transaction log to denote that all previous transactions are ready for submission. These markers in the log provide a means for the cloud payment system 415 to identify those transactions that are to be cleared and settled with the various payment networks. Once the transactions are cleared to the different payment networks, the cloud payment system will receive payment, from which the merchant can be paid for their transactions. To this end, an end-to-end balancing and reconciliation process will be established by the cloud payment system 415 to ensure that funds received from card-based transactions balance to funds deposited to merchant accounts. The cloud payment system 415 may be further configured to monitor transactions for suspicious activity (e.g. fraud) and calculate the associated fees for each type of transaction, as the cost may vary dramatically between transaction types.

In some embodiments, as shown in FIG. 9, the customer may place an order for food items before arriving at the restaurant (using the interne or a mobile phone or other device). The financial transaction processing system 901 (or the cloud payment system 415 of FIG. 4) may determine the user's location or relative location based on GPS, IP address, WIFI signal, cellular signal or other indicators provided in location information 908. The financial transaction processing system 901 may place the QR code received from the customer indicating their selection of menu items in a queue 902 until the customer 906 is within a specified distance from the restaurant 905. Thus, the financial transaction processing system 901 may, in effect, establish a “geofence” (e.g. 904A or 904B), where the user's order is placed in a queue until the user has crossed the geofence. Thus, if the user is walking to the restaurant (e.g. 906), or is driving to the restaurant (907) in a car or other vehicle, the location receiving/determining module 903 may determine that the user has moved to a physical location that is within the specified distance from the restaurant (i.e. within the geofence 904B) based on location information. 908. Once the user is within that geofence, the received QR code representing the user's order may be removed from the queue and may be processed.

In some cases, multiple geofences may be implemented, where one geofence is established to be a certain (further) distance away (e.g. geofence 904B) and the other geofence is a closer distance or is immediately surrounding the restaurant 905 (e.g. geofence 904A). In such cases, once the customer has passed the outer geofence (904B), their order may be taken off of the queue and processed. Once the customer has passed the inner geofence (904A), the financial transaction processing system 901 may determine that the customer has a picture associated with their account information and may provide that picture to the restaurant. In one embodiment, as shown in FIG. 10, the customer's order 1001 may be shown to a worker in the restaurant. The order may include the customer's picture 1002 (so that the food may be delivered to that person based on facial recognition), the customer's name 1003, the food items that were ordered 1004 and potentially an indication of whether the customer is a return customer 1005. Once the customer has been identified, a restaurant worker can provide the customer their food. In some cases, the restaurant may provide the customer with a mobile computing system on which the customer can enter a PIN to verify their order.

In some cases, the boundaries of the geofence (or geofences if multiple are in place) may be dynamically adjusted based on various factors. For instance, the boundaries of a geofence may be adjusted based on how many orders are currently in the queue. If there are multiple orders in the queue, the restaurant may need a longer time to prepare the customer's items, and may increase the size of the geofence. Conversely, if there are few (or no) orders in the queue, and the restaurant knows they can prepare the customer's order in a timely fashion, the size of the geofence may be reduced. Other criteria for varying the size of the geofence include an indication of how long internal restaurant lines are, or how many restaurant staff are on hand. Still further, the geofence may be unique to each customer, and may depend on the customer's current rate of speed (e.g. the location receiving/determining module 903 can detect that the customer is driving or walking toward the restaurant). If the user is approaching quickly, the geofence would be increased, whereas if the user was approaching slowly, the size of the geofence would be reduced. Indeed, at least in some embodiments, the size of the geofence may be dynamically adjusted based on the current determined rate of speed of the customer, as the user's speed changes. In this manner, a user may place their order at any time and then, only when they are within the geofence, will the order actually be prepared by the restaurant.

It should be noted that while the geofence concept has been described in relation to restaurants, it may be applied to any type of physical goods, electronic goods, media items or other items. Moreover, it should be noted that while QR codes have been repeatedly mentioned in the examples above, other electronic codes such as bar codes or other electronically readable codes may be used in addition to or alternative to QR codes. Other concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

We claim:

1. A computer system comprising the following:
one or more processors;
system memory;
one or more computer-readable storage media having stored thereon computer-executable instructions that, when executed by the one or more processors, causes the computing system to perform a method for performing a transaction using a quick response (QR) code, the method comprising the following:
receiving, from a purchaser, an indication of one or more items that are to be purchased using a mobile wallet application;
determining a total price for those items that are to be purchased;
receiving, from the purchaser, a tokenized QR code that includes embedded account information for the purchaser for use in processing transactions with sellers;
generating a second, different tokenized QR code that includes encrypted account information for the seller, along with encrypted account information for the purchaser and the determined total price for the items that are to be purchased;
sending the second tokenized QR code to a transaction processing node, wherein the transaction processing node transfers money equivalent to node, the determined total price from the purchaser's account to the seller's account according to the encrypted account information in the second tokenized QR code; and
receiving an electronic receipt indicating that the money was transferred from the purchaser's account to the seller's account.

2. The computer system of claim 1, further comprising:
determining that one or more discounts or loyalty points are to be applied to the purchaser's transaction to reduce the amount of the transaction; and
applying the discounts or loyalty points to the transaction to reduce the amount of the transaction by a specified amount.

3. The computer system of claim 2, wherein determining that one or more discounts or loyalty points are to be applied to the purchaser's transaction to reduce the amount of the transaction comprises determining the purchaser's purchasing history, wherein the purchaser qualifies for one or more discounts or loyalty points based on the purchaser's purchasing history.

4. The computer system of claim 1, wherein the seller specifies which payment network is to be used to route monetary transactions through.

5. The computer system of claim 1, wherein the QR code received from the purchaser is generated by the mobile wallet application.

6. The computer system of claim 5, wherein the purchaser scans the physical items that are to be purchased using a scanning means, such that the scanned items are added to a shopping cart running in the mobile wallet application.

7. The computer system of claim 1, wherein the electronic receipt is sent to both the purchaser and the seller, and includes a listing of each of the paid-for items.

8. A computer system comprising the following:
one or more processors;
system memory;
one or more computer-readable storage media having stored thereon computer-executable instructions that, when executed by the one or more processors, causes the computing system to perform a method for directly purchasing items from a seller using a quick response (QR) code, the method comprising the following:
receiving from a purchaser a tokenized QR code indicating that the purchaser has initiated a financial transaction using a mobile wallet application to pay for one or more items sold by a seller, the tokenized QR code including embedded account information for both the seller and the purchaser;
determining, from the tokenized QR code, the amount of money that is to be transferred from the purchaser to the seller as part of the financial transaction;
selecting which of one or more stored value accounts belonging to the purchaser are to be used to pay for the one or more items provided for sale by the seller;
transferring the determined amount of money from the one or more selected stored value accounts to the seller's account, according to the embedded account information in the tokenized QR code; and
sending an electronic receipt of the financial transaction to at least one of the purchaser and the seller.

9. The computer system of claim 8, wherein the purchased items include media items, and wherein the seller of the media items comprises a media producer.

10. The computer system of claim 8, wherein the purchased items comprise consumer packaged goods (CPGs), and wherein the seller comprises a CPG producer.

11. The computer system of claim 8, wherein the seller specifies which payment network is to be used to route purchaser's transaction through.

12. A computer system comprising the following:
one or more processors;
system memory;
one or more computer-readable storage media having stored thereon computer-executable instructions that, when executed by the one or more processors, causes the computing system to perform a method for performing a transaction at a restaurant using a quick response (QR) code, the method comprising the following:
receiving from a restaurant customer a tokenized QR code indicating that the restaurant customer is using a mobile wallet application to pay for one or more menu items sold by the restaurant, the tokenized QR code including embedded account information for both the restaurant and the restaurant customer, an indication of which menu items are being purchased, an indication of the total amount due, and an indication of payment instructions for the restaurant;
determining which payment network is to be used to pay for the selected menu items;
transferring the money indicated in the total amount due to from the restaurant customer's account to the restaurant's account; and
sending an electronic receipt of the transaction to at least one of the restaurant customer and the restaurant.

13. The computer system of claim 12, further comprising:
determining that one or more discounts or loyalty points are to be applied to the restaurant customer's transaction to reduce the amount of the transaction; and
applying the discounts or loyalty points to the transaction to reduce the amount of the transaction by a specified amount.

14. The computer system of claim 13, wherein determining that one or more discounts or loyalty points are to be applied to the restaurant customer's transaction to reduce the amount of the transaction comprises determining the restaurant customer's purchasing history, wherein the restaurant customer qualifies for one or more discounts or loyalty points based on the restaurant customer's purchasing history at that restaurant.

15. The computer system of claim 12, wherein determining which payment network is to be used to pay for the selected menu items is based on at least one of restaurant customer information and restaurant preference information.

16. The computer system of claim 12, further comprising:
placing the QR code received from the customer indicating a selection of one or more menu items in a queue until the customer is within a specified distance from the restaurant;
determining that the user has moved to a physical location that is within the specified distance from the restaurant; and
removing the QR code from the queue and processing the transaction according to the information stored on the QR code.

17. The computer system of claim 16, further comprising:
determining that the customer has a picture associated with their account information; and
providing the picture to the restaurant.

18. The computer system of claim 17, wherein the customer's picture is provided to the restaurant upon determining that the customer is within a second specified distance from the restaurant.

19. The computer system of claim 16, further comprising dynamically adjusting the specified distance according to one or more criteria including: how many orders are currently on queue, how long internal restaurant lines are and how many restaurant staff are on hand.

20. The computer system of claim 19, wherein the specified distance is dynamically adjusted based on the current determined rate of speed of the customer.

21. The computer system of claim 12, wherein the computer system establishes a balancing and reconciliation process that ensures that funds received from card-based transactions balance to funds deposited to merchant accounts.

22. At a computer system including at least one processor and a memory, a computer-implemented method for performing a transaction using a quick response (QR) code, the method comprising:
receiving, from a purchaser, an indication of one or more items that are to be purchased using a mobile wallet application;
determining a total price for those items that are to be purchased;
receiving, from the purchaser, a tokenized QR code that includes embedded account information for the purchaser for use in processing transactions with sellers;
generating a second, different tokenized QR code that includes encrypted account information for the seller, along with encrypted account information for the purchaser and the determined total price for the items that are to be purchased;
sending the second tokenized QR code to a transaction processing node, wherein the transaction processing node transfers money equivalent to the determined total price from the purchaser's account to the seller's account according to the encrypted account information in the second tokenized QR code; and
receiving an electronic receipt indicating that the money was transferred from the purchaser's account to the seller's account.

23. At a computer system including at least one processor and a memory, a computer-implemented method for directly purchasing items from a seller using a quick response (QR) code, the method comprising:
receiving from a purchaser a tokenized QR code indicating that the purchaser has initiated a financial transaction using a mobile wallet application to pay for one or more items sold by a seller, the tokenized QR code including embedded account information for both the seller and the purchaser;
determining from the tokenized QR code the amount of money that is to be transferred from the purchaser to the seller as part of the financial transaction;
selecting which of one or more stored value accounts belonging to the purchaser are to be used to pay for the one or more items provided by the seller;
transferring the determined amount of money from the one or more selected stored value accounts to the seller's account, according to the embedded account information in the tokenized QR code; and
sending an electronic receipt of the financial transaction to at least one of the purchaser and the seller.

24. The method of claim 23, wherein the purchaser is a restaurant customer and the seller is a restaurant, and wherein the tokenized QR code includes embedded account information for both the restaurant and the restaurant customer, an indication of which menu items are being purchased, an indication of the total amount due, and an indication of payment instructions for the restaurant.

25. A computer program product for implementing a method for directly purchasing items from a seller using a quick response (QR) code, the computer program product comprising one or more computer-readable storage media having stored thereon computer-executable instructions that, when executed by one or more processors of the computing system, cause the computing system to perform the method, the method comprising:
receiving from a seller a tokenized QR code corresponding to the seller, the tokenized QR code including embedded account information for the seller for use in processing financial transactions with the seller;
receiving from a purchaser an indication of one or more selected items sold by the seller that are to be purchased using a mobile wallet application;
determining the sum total of the price of each selected item;
generating a second, different tokenized QR code that includes the purchaser's account information, the determined sum total and the seller's account information;
sending the second, different tokenized QR code to a financial transaction processing system; and
receiving an electronic receipt indicating that the financial transaction was processed.
